(19) United States
(12) Patent Application Publication
(10) Pub. No.: US 2026/0058177 A1
(43) Pub. Date: Feb. 26, 2026

(54) SYSTEMS AND METHODS FOR FUEL CELL CATHODE EXHAUST HUMIDITY CONTROL

(71) Applicant: Caterpillar Inc., Peoria, IL (US)

(72) Inventors: Yuvasriram Balakrishnan, Chennai (IN); Balaji Kalyanarangan, Chennai (IN)

(73) Assignee: Caterpillar Inc., Peoria, IL (US)

(21) Appl. No.: 18/813,306

(22) Filed: Aug. 23, 2024

(51) Int. Cl. H01M 8/04828; H01M 8/04119; H01M 8/04492; H01M 8/04701

(52) U.S. Cl. CPC H01M 8/04843; H01M 8/04141; H01M 8/04522; H01M 8/04708

(57) ABSTRACT

A first aspect provided herein relate to a method of controlling cathode exhaust humidity. The method can include receiving, by a cathode controller, a signal indicating a sensed humidity of a cathode exhaust from a fuel cell of a machine. The method can include determining, by the cathode controller, that the sensed humidity is outside of a predetermined range. The method can include adjusting, by the cathode controller, one or more control parameters, to cause the fuel cell of the machine to produce cathode exhaust having a humidity within the predetermined range.

### TECHNICAL FIELD

The present implementations relate generally to the field of fuel cells, and more particularly systems and methods for fuel cell cathode exhaust humidity control.

### BACKGROUND

Fuel cells may be used to generate/supply electrical power in various use cases and applications. In some implementations, fuel cells may be provided as an energy source for various machinery. Such fuel cells may include proton exchange membrane (PEM) fuel cells. In a PEM fuel cell, hydrogen may be supplied to an anode loop, and oxygen may be supplied to the cathode loop. Such fuel systems may include a control system or solution which regulate the amount of oxygen supplied to the cathode loop, to prevent drying or flooding.

For example, U.S. Patent Publication No. 2007/287041 describes a control system for a fuel cell stack that maintains the relative humidity of the cathode inlet air above a predetermined percentage by doing one or more of decreasing stack cooling fluid temperature, increasing cathode pressure, and/or decreasing the cathode stoichiometry when necessary to increase the relative humidity of the cathode exhaust gas that is used by a water vapor transfer device to humidify the cathode inlet air. The control system can also limit the power output of the stack to keep the relative humidity of the cathode inlet air above the predetermined percentage.

### SUMMARY

A first aspect provided herein relate to a method of controlling cathode exhaust humidity. The method can include receiving, by a cathode controller, a signal indicating a sensed humidity of a cathode exhaust from a fuel cell of a machine. The method can include determining, by the cathode controller, that the sensed humidity is outside of a predetermined range. The method can include adjusting, by the cathode controller, one or more control parameters, to cause the fuel cell of the machine to produce cathode exhaust having a humidity within the predetermined range.

A second aspect provided herein relate to a fuel cell system. The fuel cell system can include a cathode controller. The cathode controller can be configured to receive a signal indicating a sensed humidity of a cathode exhaust from a fuel cell of a machine. The cathode controller can be configured to determine that the sensed humidity is outside of a predetermined range. The cathode controller can be configured to adjust one or more control parameters, to cause the fuel cell of the machine to produce cathode exhaust having a humidity within the predetermined range.

A third aspect provided herein relate to a cathode controller of a fuel cell. The cathode controller can include one or more processors. The one or more processors can be configured to receive a signal indicating a sensed humidity of a cathode exhaust from a fuel cell of a machine. The one or more processors can be configured to determine that the sensed humidity is outside of a predetermined range. The one or more processors can be configured to adjust one or more control parameters, to cause the fuel cell of the machine to produce cathode exhaust having a humidity within the predetermined range.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a fuel cell system for fuel cell cathode exhaust humidity control, in accordance with present implementations.

FIG. 2 is a block diagram of the fuel cell system, in accordance with present implementations.

FIG. 3 is a flowchart showing a method for fuel cell cathode exhaust humidity control, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement fuel cell cathode exhaust humidity control to maintain an optimal humidity at a cathode exhaust of the fuel cell. Fuel cells typically produce exhaust containing varying amounts of humidity based on the type of fuel cell, loads of a machine, and efficiency of the fuel cell. The fuels cells typically operate based on a stoichiometric ratio to indicate a specific amount of hydrogen from an anode that needs to interact with oxygen (or air) at the cathode in the fuel cell. In a Proton Exchange Membrane (PEM), the reaction between hydrogen and oxygen is represented as

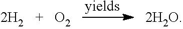

Various components of the fuel cell (e.g., pressure control valve (PCV), ejector) can increase or decrease the produced water from the reaction. However, inefficient use of the components results in decreased efficiency of the fuel cell. Furthermore, inefficient use of the components results in flooding or drying at the cathode exhaust by not properly managing humidity levels. According to the systems and methods described herein, a cathode controller can use various inputs based on sensor readings to establish an optimal range for humidity, and calculate humidity levels, in real time.

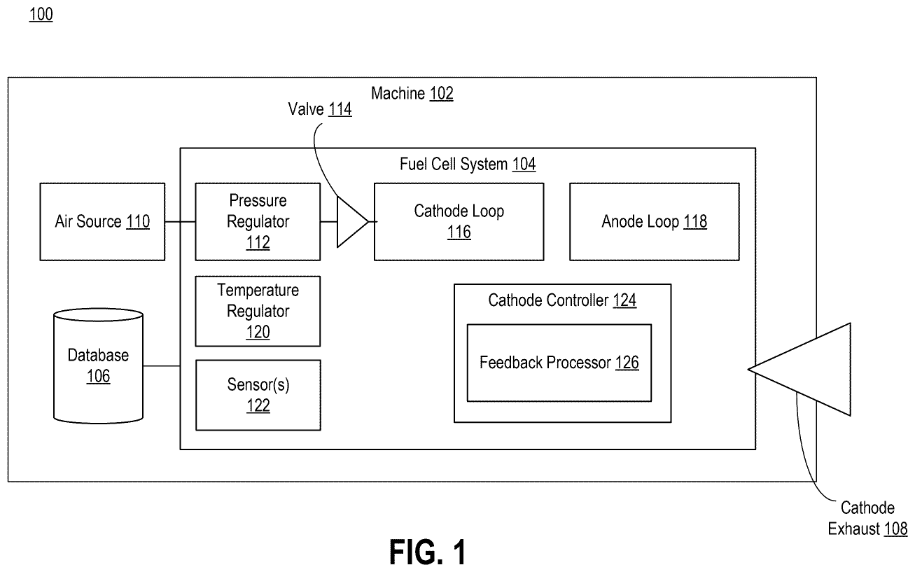

FIG. 1 is a block diagram of a system 100 for fuel cell cathode exhaust humidity control to maintain an optimal humidity at a cathode exhaust of the fuel cell. The system 100 can include at least one machine 102. The machine 102 can be any large-scale mechanical equipment (e.g., heavy machinery) utilized in industrial sectors such as construction, mining, agriculture, and manufacturing. The machine 102 can be at least one of an excavator, a bulldozer, a crane, a loader, haul trucks, a tractor, a forklift, a press machine, turbines, among others. The machine 102 can be characterized by robust construction, high-capacity operation, and the ability to perform in demanding environments, providing enhanced efficiency, safety, and reliability in industrial applications.

The machine 102 can include at least one fuel cell system 104, at least one database 106, at least one cathode exhaust 108, and at least one air source 110. The fuel cell system 104 can allow for energy conversion within the machine 102. The fuel cell system 104 can include a fuel cell stack that is composed of fuel cells. Each fuel cell can include an anode, a cathode, and an electrolyte membrane (e.g., a proton exchange membrane (PEM)). In operation, hydrogen can be supplied to the anode to produce protons and electrons. The protons can pass through the PEM to reach the cathode, while the electrons travel through an internal or external circuit (e.g., as electrical energy). Once at the cathode, the protons, electrons, and oxygen from an air source can combine to form water. The fuel cell system 104 can include at least one pressure regulator 112, at least one valve 114, at least one cathode loop 116, at least one anode loop 118, at least one temperature regulator 120, at least one sensor 122, and at least one controller (e.g., cathode controller 124).

The database 106 can be hosted on a computing device (e.g., local or remote) or processor(s) that includes a non-transitory machine-readable storage medium within (or remote from) the machine 102. The database 106 can be communicably coupled to the cathode controller 124. The database 106 can be accessed by the cathode controller 124 to extract data associated with the machine 102, fuel cell system 104, or cathode exhaust 108. For instance, the cathode controller 124 can extract data about the current load of the machine 102 from the database 106. In some implementations, the database 106 can be housed in a data center and connected to the machine 102 via a network.

The cathode exhaust 108 can be located at an outlet of the fuel cell or the fuel cell system 104 to allow excess air (e.g., oxygen) to expel through the cathode. The cathode exhaust 108 can be routed to an external exhaust or exhaust system of the machine 102. The cathode exhaust 108 can manage and optimize the expulsion of depleted air and/or water vapor (e.g., humidity) from the cathode of the fuel cell. The cathode exhaust 108 can include one or more sensors 122 to detect changes in the water vapor or depleted air. An efficient cathode exhaust 108 can extend the longevity and efficiency of the fuel cell.

The air source 110 can provide a consistent supply of ambient air (e.g., oxygen) to the cathode of the fuel cell. The air source 110 can include filters, compressors, humidifiers, among others. The filters of the air source 110 can remove particles, dust, dirt, and other contaminants from the incoming external air. The compressor of the air source 110 can compress the incoming external air for the cathode. The air source 110 can compress the air according to one or more requirements of the fuel cell within the machine 102. The humidifiers of the air source 110 can add moisture to the incoming air to maintain hydration of the PEM of the fuel cell. The air source 110 can be communicably coupled to the pressure regulator 112.

The pressure regulator 112 can be hardware or software within the fuel cell system 104 of the machine 102 to adjust the flow of gas (e.g., hydrogen, nitrogen) and air (e.g., ambient air, oxygen) to the components (i.e., cathode loop 116, anode loop 118) of the fuel cell system. The pressure regulator 112 can include a pressure control mechanism, sensors 122, a processor, among others. The pressure regulator 114 can be made of stainless steel or specialized alloys to endure the environment within the fuel cell, withstand wear and tear, and allow for reliable performance of the components within the fuel cell 104. The pressure regulator 112 can be communicably coupled to the valve 114. The pressure regulator 114 can be located downstream from the air source 110 and upstream from the valve 114.

The fuel cell system 104 may include a valve 114 fluidically coupled to the pressure regulator 112. The valve 114 may be configured to direct, blow, provide, or otherwise supply air (e.g., oxygen [O₂]) from the air source 110 to the cathode loop 116. For example, the valve 114 may control the flow of air from the pressure regulator 112 within the fuel cell system 104. Upon entry to the pressure regulator 112, the valve 114 may direct or otherwise provide oxygen to the to the cathode loop 116.

The fuel cell system 104 can include the cathode loop 116 and the anode loop 118. As described in greater detail below, the anode loop 118 may be configured to be supplied with hydrogen. The cathode loop 116 may be supplied with oxygen. The anode loop 118 and cathode loop 116 may supply the hydrogen and oxygen to a PEM, which converts the hydrogen into protons and electrons, the protons interacting with the oxygen for producing heat and water, and the electrons supplied as power.

The temperature regulator 120 of the fuel cell system can be hardware or software within to regulate the temperature within the fuel cell system 104. The temperature regulator 120 can include a temperature control mechanism, sensors 122, a processor, among others. The temperature regulator 120 can be made of stainless steel or specialized alloys to endure the environment within the fuel cell (e.g., high temperatures), withstand wear and tear, and allow for reliable performance of the components within the fuel cell 104.

The sensors 122 of the fuel cell system 104 can include a plurality of sensors to monitor various conditions within the fuel cell system 104. The sensors 122 can include at least one of temperature sensor, a pressure sensor, a humidity sensor, an oxygen sensor, a voltage sensor, a current sensor, a flow rate sensor, a gas sensor, among others. The sensors 122 can be electrically coupled to, communicably coupled to, fluidically coupled to, or inside various components of the fuel cell system 104. For instance, a temperature sensor 122 can be electrically coupled to the temperature regulator 120 and arranged at a position to detect a temperature upstream or downstream from the temperature regulator 120.

The cathode controller 124 can include general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. The cathode controller 124 can be electrically coupled to the various components described herein to control changes to maintain an optimal humidity for the fuel cell system 104 and the machine 102. The cathode controller 124 can include at least one feedback processor 126.

The feedback processor 126 can use one or more algorithms to allow for real time analysis of signals received from the various components of the fuel cell system 104. The feedback processor 126 can continuously generate signals to adjust one or more control parameters based on signals received by the cathode controller 124. The one or more algorithms can include proportional integral derivative (PID) algorithms, fuzzy logic, model predictive control, among others. Each algorithm can include one or more variables such as, temperature, pressure, flow rate, among others.

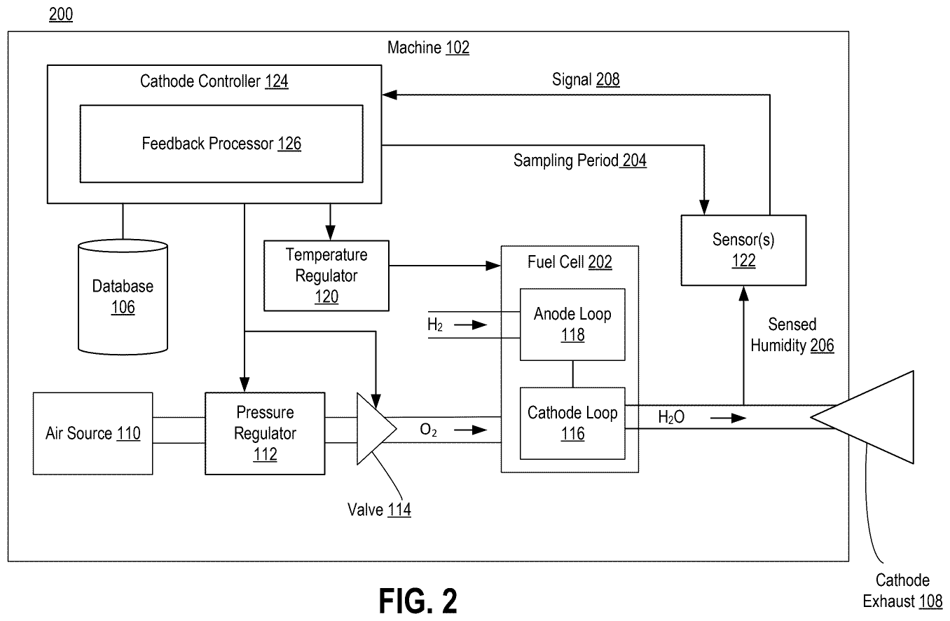

FIG. 2 is a block diagram 200 of the fuel cell system 104. The air source 110 can be fluidically coupled to the cathode loop 116 (e.g., via the pressure regulator 112 and the valve 114). In this regard, the term fluidically coupled encompasses both direct and indirect fluid connections. The air source 110 can be configured to provide, supply, or otherwise transmit air (e.g., O₂) to a pressure regulator 112. For example, the air source 110 can supply a continuous rate of oxygen to the pressure regulator 112. Prior to supplying the air, the air source 110 can include one or more filters to filter the air to be supplied to the cathode loop 116 of the fuel cell 202. For example, the air source 110 can include a filter to remove dust, particles, and other contaminants from the air before the air is supplied to the pressure regulator 112. In this manner, the air source 110 can provide clean air to the cathode loop 116 and enhance the longevity of the fuel cell 202.

Downstream from the air source 110, the pressure regulator 112 can be fluidically coupled to the air source 110. The pressure regulator 112 can receive, retrieve or otherwise obtain air from the air source 110. For example, the pressure regulator 112 can receive air from the air source 110 through an inlet of the pressure regulator 112. The pressure regulator 112 can be configured to increase, decrease, or otherwise adjust the pressure of the received air from the air source 110 according to a signal from the cathode controller 124. For example, the pressure regulator 112 can increase the pressure of the received air from the air source 110 upon reception of the signal from the cathode controller 124. In another example, the pressure regulator 112 can decrease the pressure of the received air from the air source upon reception of the signal from the cathode controller 124.

Downstream from the pressure regulator 112, the valve 114 can be fluidically coupled to the pressure regulator 112 and the air source 110 (e.g., via the pressure regulator 112). The valve 114 can be configured to direct, blow, provide, or otherwise supply air from the air source 110 to the cathode loop 116. For example, the valve 114 can direct the air from the air source 110 into the cathode loop 116. In another example, the valve 114 can direct the air to the cathode loop 116 at the adjusted pressure by the pressure regulator 112. The valve 114 can be configured to open or close based on a signal from the cathode controller 124. By opening or closing the valve 114, the cathode controller can control the flow rate of the air within the machine 102. For example, as the valve 114 opens, the flow rate of air can increase to allow more air to enter the cathode loop 116. In another example, as the valve 114 closes, the flow rate of air can decrease to allow less air to enter the cathode loop 116.

In some embodiments, the anode loop 118 can be fluidically coupled to a hydrogen source. The hydrogen source can supply hydrogen to the anode loop via a second pressure regulator. The second pressure regulator can be configured to increase, decrease, or otherwise adjust a pressure/volumetric flow of the hydrogen from the hydrogen source for supply to the PEM (e.g., the anode loop 118 of the PEM fuel cell 202 correspond to the fuel cell system 104). As described above, the cathode loop 116 can have air (e.g., ambient air, oxygen) supplied thereto. Using hydrogen supplied to the anode loop 118 and oxygen from the cathode loop 116, the fuel cell 202 may produce electrical energy and heat for one or more fuel cells. For example, the fuel cell 202 may generate or produce electrical energy by splitting the hydrogen of the anode loop 118 protons and electrons, whereas the oxygen of the cathode loop 116 may combine with the protons and electrons to produce electricity, and water (H₂O) with heat generated as a byproduct.

The cathode loop 116 can transmit, send, or otherwise provide the water byproduct to the cathode exhaust 108. For example, when the oxygen of the cathode loop 116 combines with the protons and electrons to produce water as a byproduct, the water may exit (e.g., as steam or in a liquid state) via the cathode exhaust 108. In other words, water can be in liquid or gaseous state when in the cathode exhaust 108. When the water is produced by the cathode loop 116, levels of humidity at the cathode exhaust 108 may increase or decrease based on the amount of water produced, the temperature of the fuel cell 202, the pressure of air, and the flow rate of the air. For example, the machine 102 can have an increased load. To accommodate for the increased load, the cathode loop 116 of the fuel cell 202 can produce a high amount of water thereby increasing levels of humidity at the cathode exhaust 108.

When the levels of humidity are outside of an optimal or predetermined range, the machine 102 can have reduced performance and decreased longevity. The optimal range for the humidity can be between 80-100% humidity. For example, the levels of humidity can be at 115% humidity, which can cause flooding at the cathode exhaust 108 of the machine 102, causing a decrease in performance. In another example, the levels of humidity can be at 74% humidity, which can cause drying at the cathode exhaust 108 of the machine 102, causing a decrease in performance. When the level of humidity is in the optimal range, the machine 102 can have optimal performance and maximize longevity. For example, the levels of humidity can be at 95% humidity to maintain optimal performance of the machine 102. In another example, the levels of humidity can be at 90% humidity to maintain optimal performance of the machine 102.

Prior to detecting the sensed humidity 206, the cathode controller 124 can generate, create, or otherwise determine a sampling period 204 for the sensors 122. The sampling period 204 can include one or more intervals for the humidity sensor 122 to detect the sensed humidity 206 of the cathode exhaust 108. The cathode controller 124 can access data within the database 106 to identify the sampling period 204 for the humidity sensor 122 based on the machine 102. For example, a haul truck 102 can have a different sampling period 204 than an excavator 102. In another example, a bulldozer 102 can have a different sampling period 204 than a drill 102. By using the specifications of the respective machine 102 within the database 106, the cathode controller 124 can generate the sampling period 204. For example, the sampling period 204 can be 1-5 minutes. In another example, the sampling period 204 can be 30 seconds to 5 minutes. In some embodiments, the cathode controller 124 can receive, obtain, or otherwise identify the sampling period 204 from an operator of the machine 102.

The sensors 122, specifically a humidity sensor 122, can detect, monitor, or otherwise generate data indicative of a sensed humidity 206 at the cathode exhaust 108, at the sampling period 204. The sensed humidity 206 can be an absolute humidity which quantifies or measures an amount or percentage of water vapor present within the cathode exhaust 108. For example, the humidity sensor 122 can continuously read the sensed humidity 206 at the cathode exhaust 108 while the machine 102 is in operation, according to the sampling period 204. The sensed humidity 206 can be a relative humidity that measures a percentage of the amount of moisture the air in the cathode exhaust 108 can hold. The relative humidity may change in accordance with the temperature at the cathode exhaust 108. For example, as the temperature increases, the sensed humidity 206 at the cathode exhaust can increase. As another example, as the temperature decreases, the sensed humidity 206 at the cathode exhaust may decrease.

The humidity sensor 122 can generate, create, or otherwise compute a signal 208 upon detection that the sensed humidity 206 is outside of the predetermined range. For example, the humidity sensor 122 can detect that the sensed humidity 206 is 106 percent. From here, the humidity sensor 122 can generate the signal 208 indicating the sensed humidity 206. The signal 208 can indicate that the sensed humidity 206 is above the predetermined range. In another example, the humidity sensor 122 can detect that the sensed humidity 206 is 63 percent. From here, the humidity sensor 122 can generate the signal 208 indicating the sensed humidity 206. The signal 208 can indicate that the sensed humidity 206 is below the predetermined range. Once the signal 208 is generated, the humidity sensor 122 can transmit, send, or otherwise provide the signal 208 to the cathode controller 124.

The cathode controller 124 can receive, extract, or otherwise obtain the signal 208 from the humidity sensor 122 to identify the sensed humidity 206. The signal 208 can indicate whether the sensed humidity 206 is above, below, or within the predetermined range. For example, upon reception of the signal 208, the cathode controller 124 can receive the signal 208 from the humidity sensor 122 and identify the sensed humidity 206. Concurrently, the cathode controller 124 can access the database 106 to retrieve, obtain, or otherwise extract the predetermined range of humidity for the machine 102.

The cathode controller 124 can detect, identify, or otherwise report changes in the sensed humidity 206 by comparing the sensed humidity 206 with a stored rate of change for sensed humidity 206 within the database 106. The rate of change may indicate a threshold for changes to the sensed humidity 206. In the event that the cathode controller 124 detects a rate of change in the sensed humidity 206 (e.g., over time) which is greater than the stored rate of change, the cathode controller 124 can report the change as “sharp.” For example, the humidity sensor 122 can detect and report sharp changes in the sensed humidity 206 as the load of the machine 102 changes, within the sampling period 204. The external humidity can increase or decrease moisture within the cathode exhaust 108. For example, the external humidity can cause the sensed humidity 206 within the cathode exhaust 108 to increase. For case of description, while the cathode controller 124 detects changes in the sensed humidity 206, the humidity 122 can detect changes in the sensed humidity 206.

The cathode controller 124 can determine, identify, or otherwise detect that the sensed humidity 206 is outside of the predetermined range. To determine that the sensed humidity 206 is outside of the predetermined range, the cathode controller 124 can compare the sensed humidity 206 and the predetermined range. For example, the sensed humidity 206 can be 74 percent. The cathode controller 124 can determine that the sensed humidity 206 is outside of the predetermined range and that the cathode exhaust 108 is at risk of drying. In another example, the sensed humidity 206 can be 152 percent. The cathode controller 124 can determine that the sensed humidity 206 is outside of the predetermined range and that the cathode exhaust 108 is at risk of flooding.

The cathode controller 124 can adjust, change, or otherwise update one or more control parameters. The one or more control parameters can be at least one of temperature (e.g., temperature of the fuel cell 202, temperature of the air entering the fuel cell 202), cathode pressure (e.g., pressure of the air entering the cathode loop 116), ratio of oxygen to hydrogen, flow rate, among others. For example, the cathode controller 124 can adjust the cathode pressure and the temperature of the air entering the fuel cell 202. As another example, the cathode controller 124 can adjust the ratio of oxygen to hydrogen entering the fuel cell 202 by adjust the flow rate of oxygen and hydrogen. By adjusting the flow rate, the number of moles of oxygen or the number of moles of hydrogen may increase or decrease to achieve a desired ratio for the cathode exhaust 108.

The cathode controller 124 can adjust, change, or otherwise update one or more control parameters, to cause the fuel cell of the machine to produce cathode exhaust having a humidity within the predetermined range. Each control parameter of the one or more control parameters can have a different level of impact from a different control parameter based on the machine 102. For example, the ratio of oxygen to hydrogen can have a higher impact on adjusting the humidity in comparison to the temperature of the fuel cell 202 for the machine 102. The cathode controller 124 can choose to adjust at least one parameter based on the level of deviation from the predetermined range. For example, the cathode controller 124 can adjust the temperature of the fuel cell 202 when the sensed humidity 206 is a small deviation away from the predetermined range. In another example, the cathode controller 124 can adjust the pressure when the sensed humidity 206 is a small deviation away from the predetermined range. In yet another example, the cathode controller 124 can adjust the pressure, temperature of the fuel cell, the ratio of oxygen to hydrogen when the sensed humidity 206 is a large deviation away from the predetermined range.

Responsive to the cathode controller 124 determining that the sensed humidity 206 is greater than the predetermined range (i.e., greater than 100 percent), the cathode controller 124 can identify, determine, or otherwise generate a rate to decrease to humidity at the cathode exhaust 108. The cathode controller 124 can identify the rate based on a level of deviation from the predetermined range. The database 106 can store, house or otherwise maintain ranges for each level of deviation from the predetermined range. Using the ranges, the cathode controller 124 can level the level as “large” or “small. For example, when the sensed humidity 206 is a large deviation (e.g., sensed humidity 206 is greater than 20% humidity from the predetermined range) away from the predetermined range, the cathode controller 124 can calculate a higher rate. In another example, when the sensed humidity 206 is a small deviation (e.g., sensed humidity 206 is less than 20% humidity from the predetermined range) away from the predetermined range, the cathode controller 124 can calculate a lower rate.

Upon calculating the rate, the cathode controller 124 can adjust the one or more control parameters at the rate to decrease the humidity of the cathode exhaust 108. For example, the cathode controller 124 can reduce the cathode pressure at the rate to reduce the humidity. In another example, the cathode controller 124 can reduce the temperature of the fuel cell 202, at the rate, to reduce the humidity. In yet another example, the cathode controller 124 can reduce the temperature of the fuel cell 202, the flow rate, and the ratio of oxygen to hydrogen at the rate to reduce the humidity.

Responsive to the cathode controller 124 determining that the sensed humidity 206 is less than the predetermined range (i.e., less than 100 percent), the cathode controller 124 can identify, determine, or otherwise generate a rate to increase to humidity at the cathode exhaust 108. The cathode controller 124 can identify the rate based on the level of deviation. For example, when the sensed humidity 206 is a large deviation away from the predetermined range, the cathode controller 124 can calculate a higher rate. In another example, when the sensed humidity 206 is a small deviation away from the predetermined range, the cathode controller 124 can calculate a lower rate.

Upon calculating the rate, the cathode controller 124 can adjust the one or more control parameters at the rate to increase the humidity of the cathode exhaust 108. For example, the cathode controller 124 can increase the cathode pressure at the rate to increase the humidity to prevent drying of the cathode exhaust 108. In another example, the cathode controller 124 can increase the temperature of the fuel cell 202, at the rate, to increase the humidity to prevent drying of the cathode exhaust 108. In yet another example, the cathode controller 124 can increase the temperature of the fuel cell 202, the flow rate, and the ratio of oxygen to hydrogen at the rate to increase the humidity to prevent drying of the cathode exhaust 108.

To adjust the one or more control parameters, the cathode controller 124 can use the feedback processor 126 to execute a feedback control loop by using the sensed humidity 206. The cathode controller 124 can determine the humidity as a function of the sensed humidity 206 and the one or more control parameters of the fuel cell 202. For example, the feedback processor 126 can use the sensed humidity 206 and the one or more control parameters to generate the rate to increase or decrease the humidity to be in the predetermined range.

The cathode controller 124 can control the pressure regulator 112, by executing the feedback control loop. For example, by executing the feedback control loop, using the sensed humidity 206, the cathode controller 124 can reduce the cathode pressure of the fuel cell 202, provided by the pressure regulator 112. In another example, by executing the feedback control loop, using the sensed humidity 206, the cathode controller 124 can increase the cathode pressure of the fuel cell 202, provided by the pressure regulator 112. In yet another example, by executing the feedback control loop, using the sensed humidity 206, the cathode controller 124 may maintain the cathode pressure of the fuel cell 202, provided by the pressure regulator 112.

To control the pressure regulator 112, the cathode controller 124 can generate, create, or otherwise identify a pressure regulator control signal for the pressure regulator 112. The pressure regulator control signal can include instruction to increase, decrease, or adjust the amount of cathode pressure based on the humidity. For example, the pressure regulator control signal can cause the pressure regulator 112 to increase the cathode pressure of the fuel cell 202, responsive to determining that the sensed humidity 206 is below the predetermined range. In another example, the pressure regulator control signal can cause the pressure regulator 112 to decrease the cathode pressure of the fuel cell 202, responsive to determining that the sensed humidity 206 is above the predetermined range.

The cathode controller 124 can control the temperature regulator 120, by executing the feedback control loop. For example, by executing the feedback control loop, using the sensed humidity 206, the cathode controller 124 can reduce the air temperature of the fuel cell 202, provided by the temperature regulator 120. In another example, by executing the feedback control loop, using the sensed humidity 206, the cathode controller 124 can increase the air temperature of the fuel cell 202, provided by the temperature regulator 120. In yet another example, by executing the feedback control loop, using the sensed humidity 206, the cathode controller 124 may maintain the air temperature of the fuel cell 202, provided by the temperature regulator 120.

To control the temperature regulator 120, the cathode controller 124 can generate, create, or otherwise identify a temperature regulator control signal for the temperature regulator 120. The temperature regulator control signal can include instructions to increase, decrease, or adjust the amount of air temperature based on the humidity. For example, the temperature regulator control signal can cause the temperature regulator 120 to increase the air temperature of the fuel cell 202, responsive to determining that the sensed humidity 206 is below the predetermined range. In another example, the temperature regulator control signal can cause the temperature regulator 120 to decrease the air temperature of the fuel cell 202, responsive to determining that the sensed humidity 206 is above the predetermined range.

The cathode controller 124 can control the temperature regulator 120, by executing the feedback control loop. For example, by executing the feedback control loop, using the sensed humidity 206, the cathode controller 124 can reduce the air temperature of the fuel cell 202, provided by the temperature regulator 120. In another example, by executing the feedback control loop, using the sensed humidity 206, the cathode controller 124 can increase the air temperature of the fuel cell 202, provided by the temperature regulator 120. In yet another example, by executing the feedback control loop, using the sensed humidity 206, the cathode controller 124 may maintain the air temperature of the fuel cell 202, provided by the temperature regulator 120.

To control the temperature regulator 120, the cathode controller 124 can generate, create, or otherwise identify a temperature regulator control signal for the temperature regulator 120. The temperature regulator control signal can include instructions to increase, decrease, or adjust the amount of air temperature based on the humidity. For example, the temperature regulator control signal can cause the temperature regulator 120 to increase the air temperature of the fuel cell 202, responsive to determining that the sensed humidity 206 is below the predetermined range. In another example, the temperature regulator control signal can cause the temperature regulator 120 to decrease the air temperature of the fuel cell 202, responsive to determining that the sensed humidity 206 is above the predetermined range.

The cathode controller 124 can control the valve 114, by executing the feedback control loop. For example, by executing the feedback control loop, using the sensed humidity 206, the cathode controller 124 can reduce the opening of the valve 114. In another example, by executing the feedback control loop, using the sensed humidity 206, the cathode controller 124 can increase the opening of the valve 114. In yet another example, by executing the feedback control loop, using the sensed humidity 206, the cathode controller 124 may maintain the opening of the valve 114.

To control the valve 114, the cathode controller 124 can generate, create, or otherwise identify a valve control signal for the valve 114. The valve control signal can include instructions to increase, decrease, or adjust the amount of oxygen supplied to the cathode loop 116. For example, the valve control signal can cause the valve 114 to open and increase the amount of oxygen supplied to the cathode loop 116, responsive to determining that the sensed humidity 206 is below the predetermined range. In another example, the valve control signal can cause the valve 114 to close and decrease the amount of oxygen supplied to the cathode loop 116, responsive to determining that the sensed humidity 206 is above the predetermined range.

### INDUSTRIAL APPLICABILITY

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells, or fuel cells which struggle to control humidity within the cathode exhaust 108. The disclosed cathode controller 124 can be provided to optimize humidity control within the fuel cell system 104, by simultaneously controlling the pressure regulator 112, the valve 114, and the temperature regulator 120 to maintain optimal efficiency of the fuel cell system 104 based on feedback according to the sensed humidity 206. For example, the cathode controller 124 can trigger the valve 114 to open or close, the pressure regulator 112 to increase or decrease pressure, and/or the temperature regulator 120 to increase or decrease air temperature of the fuel cell 202.

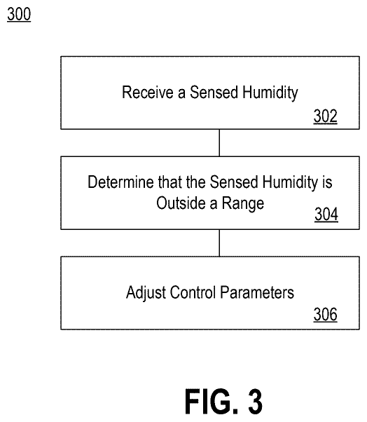

Referring now to FIG. 3, depicted is a flowchart showing an example method 300 for the cathode exhaust humidity control of fuel cells. The method 300 may be performed by, implemented on, or otherwise executed by the components, elements, or hardware described above with reference to FIG. 1 and FIG. 2. For example, the method 300 may be executed by the components of FIG. 1. As a brief overview, at step 302, a cathode controller 124 can receive a sensed humidity. At step 304, the cathode controller 124 can determine that the sensed humidity is outside a range. At step 306, the cathode controller 124 can adjust one or more control parameters.

At step 302, a cathode controller 124 can receive a sensed humidity 206. The valve 114 can supply oxygen from the air source 110 to the cathode loop 116. In some embodiments, the pressure regulator 112 can supply oxygen from the air source 110. Once the pressure regulator 114 receives oxygen from the air source 110, the valve 114 can supply oxygen to the cathode loop 116. The cathode controller 124 can receive a signal 208 indicating the sensed humidity 206 of a cathode exhaust 108 from a fuel cell 202 of a machine 102. One or more sensors 122 can detect the sensed humidity 206 from the cathode exhaust 108. Prior to detecting the sensed humidity 206, the cathode controller can transmit a sampling period 204 to the sensors 122. The sensors 122 can detect the sensed humidity 206 at one or more intervals of the sampling period. The sensors 122 can transmit the signal 208 to the cathode controller 124, on demand, at the sampling period 204, or periodically, when the sensed humidity 206 is above or below a threshold.

At step 304, the cathode controller 124 can determine that the sensed humidity 206 is outside a range. The cathode controller 124 can compare the sensed humidity 206 to the predetermined range within a database 106 to determine that the sensed humidity 206 is outside of the predetermined range. When the sensed humidity 206 is below the predetermined range, the cathode controller 124 can calculate a rate to increase the humidity to enter the predetermined range. When the sensed humidity 206 is above the predetermined range, the cathode controller 124 can calculate a rate to decrease the humidity to enter the predetermined range.

At step 306, the cathode controller 124 can adjust one or more control parameters. The cathode controller 124 can adjust the one or more control parameters to cause the fuel cell 202 of the machine 102 to produce cathode exhaust 108 having a humidity within the predetermined range. The one or more control parameters can include air temperature, cathode pressure, and air stoichiometry, among others. For example, if the sensed humidity 206 is below the predetermined range, the cathode controller 124 can adjust the one or more control parameters according to the rate to increase the humidity. For example, if the sensed humidity 206 is above the predetermined range, the cathode controller 124 can adjust the one or more control parameters according to the rate to decrease the humidity.

To adjust the one or more control parameters, the cathode controller 124 can use a feedback processor 126 to execute a feedback control loop. The feedback control loop can control the valve 114, the pressure regulator 112, and the temperature regulator 120 to produce the cathode exhaust having the humidity within the predetermined range. The cathode controller 124 can determine the output humidity as a function of the sensed humidity 206 and the one or more control parameters of the fuel cell. Once the output humidity is determined, the cathode controller 124 can transmit a second signal indicating the one or more control parameters to the fuel cell of the machine. The second signal can cause the fuel cell 202 of the machine 102 to produce cathode exhaust having the humidity within the predetermined range.

The feedback processor 126 can generate the second signal by executing the feedback control loop. The second signal can control the valve 114. For example, the second signal can cause the valve 114 to open and increase the amount of oxygen supplied to the cathode loop 116, thereby, increasing the humidity at the cathode exhaust 108. The second signal can control the temperature regulator 120. For example, the second signal can cause the temperature regulator to increase the air temperature of the fuel cell 202 and increase the humidity at the cathode exhaust 108. The second signal can control the pressure regulator 112. For example, the second signal can control the pressure regulator 112 to decrease the pressure at the cathode loop 116, thereby, decreasing the humidity at the cathode exhaust 108.

By using the systems and methods described herein to modify the humidity of the exhaust to be within the predetermined range, the cathode controller may protect the cathode exhaust from flooding, protect the cathode exhaust from drying, improve inefficient use of the components resulting in improved longevity of the machine and improved efficiency of the full cell by properly managing the humidity levels at the cathode exhaust. Furthermore, the system and methods described herein can decrease the impact on the environment by reducing wasted fuel at the cathode exhaust from inefficient use of the components of the machine. Overall, the systems and methods described herein provide improvements to management of the fuel cell(s) of the machine.

What is claimed is:

1. A method of controlling cathode exhaust humidity, comprising:
receiving, by a controller, a signal indicating a sensed humidity of a cathode exhaust from a fuel cell of a machine;
determining, by the controller, that the sensed humidity is outside of a predetermined range; and
adjusting, by the controller, one or more control parameters, to cause the fuel cell of the machine to produce the cathode exhaust having a humidity within the predetermined range.

2. The method of claim 1, wherein the predetermined range is between 80 to 100 percent.

3. The method of claim 1, wherein the one or more control parameters include air temperature, cathode pressure, and a ratio of oxygen to hydrogen.

4. The method of claim 1, further comprising:
receiving, by the controller, one or more intervals of a sampling period of the sensed humidity; and
monitoring, by the controller, the sensed humidity of the cathode exhaust according to the sampling period of the sensed humidity.

5. The method of claim 1, wherein adjusting the one or more control parameters further comprising:
responsive to determining that the sensed humidity is below the predetermined range, identifying, by the controller, a rate to increase the humidity at the cathode exhaust; and
adjusting, by the controller, the one or more control parameters at the rate.

6. The method of claim 1, wherein adjusting the one or more control parameters further comprising:
responsive to determining that the sensed humidity is above the predetermined range, identifying, by the controller, a rate to decrease the humidity at the cathode exhaust; and
adjusting, by the controller, the one or more control parameters at the rate.

7. The method of claim 1, further comprising transmitting, by the controller, a second signal indicating the one or more control parameters to the fuel cell of the machine, causing the fuel cell of the machine to produce the cathode exhaust having the humidity within the predetermined range.

8. The method of claim 1, further comprising executing, by the controller, a feedback control loop to control i) a pressure regulator fluidically coupled to a valve and configured to adjust a cathode pressure of a cathode loop the fuel cell, ii) a temperature regulator configured to adjust an air temperature of the fuel cell, and iii) the valve fluidically coupled to an air source and configured to supply air to the cathode loop of the fuel cell, to produce the cathode exhaust having the humidity within the predetermined range.

9. The method of claim 8, further comprising determining, by the controller, the humidity as a function of the sensed humidity and the one or more control parameters of the fuel cell.

10. A fuel cell system, comprising:
a cathode controller, configured to:
receive a signal indicating a sensed humidity of a cathode exhaust from a fuel cell of a machine;
determine that the sensed humidity is outside of a predetermined range; and
adjust one or more control parameters, to cause the fuel cell of the machine to produce the cathode exhaust having a humidity within the predetermined range.

11. The fuel cell system of claim 10, wherein the predetermined range is between 80 to 100 percent.

12. The fuel cell system of claim 10, wherein the one or more control parameters include air temperature, cathode pressure, and air stoichiometry.

13. The fuel cell system of claim 10, wherein the cathode controller is configured to:
receive one or more intervals of a sampling period of the sensed humidity; and
monitor the sensed humidity of the cathode exhaust according to the sampling period of the sensed humidity.

14. The fuel cell system of claim 10, wherein, when adjusting the one or more control parameters, the cathode controller is configured to:
responsive to determining that the sensed humidity is below the predetermined range, identify a rate to increase the humidity at the cathode exhaust; and
adjust the one or more control parameters at the rate.

15. The fuel cell system of claim 10, wherein, when adjusting the one or more control parameters, the cathode controller is configured to:
responsive to determining that the sensed humidity is above the predetermined range, identify a rate to decrease the humidity at the cathode exhaust; and
adjust the one or more control parameters at the rate.

16. The fuel cell system of claim 10, the cathode controller is configured to transmit, a second signal indicating the one or more control parameters to the fuel cell of the machine, causing the fuel cell of the machine to produce the cathode exhaust having the humidity within the predetermined range.

17. The fuel cell system of claim 10, further comprising:
a pressure regulator fluidically coupled to a valve and configured to adjust a cathode pressure of a cathode loop of the fuel cell;
a temperature regulator configured to adjust an air temperature of the fuel cell; and
the valve fluidically coupled to an air source and configured to supply air to the cathode loop of the fuel cell, wherein the cathode controller executes a feedback control loop, to control the pressure regulator, the temperature regulator, and the valve, to produce the cathode exhaust having the humidity within the predetermined range.

18. The fuel cell system of claim 17, the cathode controller is configured to determine the humidity as a function of the sensed humidity and the one or more control parameters of the fuel cell.

19. A cathode controller, comprising:
one or more processors configured to:
receive a signal indicating a sensed humidity of a cathode exhaust from a fuel cell of a machine;
determine that the sensed humidity is outside of a predetermined range; and
adjust one or more control parameters, to cause the fuel cell of the machine to produce the cathode exhaust having a humidity within the predetermined range.

20. The cathode controller of claim 19, wherein the one or more processors are configured to execute a feedback control loop to control i) a pressure regulator fluidically coupled to a valve and configured to adjust a cathode pressure of a cathode loop of the fuel cell, ii) a temperature regulator configured to adjust an air temperature of the fuel cell, and iii) the valve fluidically coupled to an air source and configured to supply air to the cathode loop of the fuel cell, to produce the cathode exhaust having the humidity within the predetermined range.
